(19) United States
(12) Patent Application Publication
(10) Pub. No.: US 2018/0331842 A1
(43) Pub. Date: Nov. 15, 2018

(54) GENERATING A TRANSCRIPT TO CAPTURE ACTIVITY OF A CONFERENCE SESSION

(71) Applicant: Microsoft Technology Licensing, LLC, Redmond, WA (US)

(72) Inventors: Jason Thomas FAULKNER, Seattle, WA (US); Sonu ARORA, Kirkland, WA (US); Santhosh Kumar MISRO, Issaquah, WA (US)

(21) Appl. No.: 15/636,516

(22) Filed: Jun. 28, 2017

Related U.S. Application Data
(60) Provisional application No. 62/506,454, filed on May 15, 2017.

(51) Int. Cl. H04L 12/18; H04N 7/15

(52) U.S. Cl. CPC H04L 12/1831; H04N 7/15; H04L 12/1822

(57) ABSTRACT

Described herein is a system configured to generate and/or display a transcript associated with a conference session. The transcript can include text reflecting words spoken during the conference session and markers that describe activity that occurs in the conference session. The transcript can be used to determine an activity hotspot (e.g., bursts of activity) so that a user can efficiently and effectively locate a time in the conference session where engagement among participants is strongest. For example, via the transcript, a user can locate a moment when a general audience sentiment was “happy” or the audience generally “liked” what was spoken or what was presented during a conference session.

### PRIORITY APPLICATION

This application claims the benefit of and priority to U.S. Provisional Application No. 62/506,454 filed May 15, 2017, the entire contents of which are incorporated herein by reference.

### BACKGROUND

At present, the use of conference (e.g., videoconference) systems in personal, enterprise, broadcast, and/or commercial settings has increased dramatically so that meetings between people in remote locations can be facilitated. Conference systems allow users, in two or more remote locations, to communicate interactively with each other via live, simultaneous two-way video streams, audio streams, or both. Some conference systems (e.g., CISCO WEBEX provided by CISCO SYSTEMS, Inc. of San Jose, Calif., GOTOMEETING provided by CITRIX SYSTEMS, INC. of Santa Clara, Calif., ZOOM provided by ZOOM VIDEO COMMUNICATIONS of San Jose, Calif., GOOGLE HANGOUTS by ALPHABET INC. of Mountain View, Calif., and SKYPE FOR BUSINESS provided by the MICROSOFT CORPORATION, of Redmond, Wash.) also allow users to exchange files and/or share display screens that present, for example, images, text, video, applications, online locations, social media, and any others.

Consequently, conference systems enable a user to participate in a conference session (e.g., a meeting, a broadcast presentation, etc.) via a remote device. However, conventional conference systems are ineffective with respect to detecting, summarizing, and/or presenting activity that occurs in the conference session.

### SUMMARY

The disclosed system addresses the problems described above. Specifically, the disclosed system is configured to generate and/or display a transcript associated with a conference session. As described herein, the transcript can include text reflecting words spoken during the conference session. A portion or snippet of the text can be associated with a timestamp that indicates when, in the conference session, the text was spoken with respect to a point of playback (e.g., at the one minute mark of the conference session, at the ten minute mark of the conference session, etc.). In one example, the words can be spoken by one or more presenters in a “broadcast” type scenario (e.g., an executive officer of a company may be giving a presentation to employees of the company via a conference session). In another example, the words can be spoken by one or more participants in a “collaboration” meeting type scenario (e.g., a team or a group that includes five, ten, fifteen, etc. people may meet to discuss and edit a work product about to be released). The transcript can further include markers that describe activity that occurs in the conference session. The activity can be detected by the system and added to the transcript and/or manually added to the transcript (e.g., by a host or conductor of the conference session). A marker associated with an individual instance of activity can also be associated with a timestamp that indicates when, in the conference session, the activity occurs with respect to a point of playback (e.g., at the two minute mark of the content of the conference session, at the twenty minute mark of the content of the conference session, etc.).

Based on the timestamps described above, the positions of the markers that describe the activity that occurs in the conference session can be interspersed within the text reflecting the words spoken during the conference session based on times at which the activity occurs with respect to a point of playback in the conference session. The activity comprises different types of notable events. For instance, a type of notable event for which a marker is added to the transcript can include a reaction that reflects sentiment of a participant to the conference session (e.g., a viewer that tunes into the conference session). In some examples, the reaction can be selected by the participant from a menu of possible reactions (e.g., sub-types of the broader “reaction” type of notable event). The menu of possible reactions can be displayed to the participant (e.g., a “like” reaction, a “dislike” reaction, an “angry” reaction, a “happy” reaction, an “applause” reaction, etc.). Thus, the menu of possible reactions (e.g., selectable sentiment icons, selectable emojis, etc.) can include a variety of choices that represent a range of reactions that capture different types of sentiment so the system can detect a general response (e.g., of an audience) to what is being said in the conference session and/or to what is being presented in the conference session. The general response can be reflected in the transcript. In other examples, the reaction can be detected by the system without a specific user selection via a client computing device (e.g., one or more sensors can detect audible sound and/or gestures that reflect an “applause” reaction).

In additional examples, a type of a notable event can comprise: a participant joining the conference session, a participant leaving the conference session, a comment submitted to a chat conversation associated with the conference session, a modification made to file content (e.g., a page of a document, a slide in a presentation, etc.) displayed in the conference session, a poll that is conducted during the conference session, a vote in response to a poll that is conducted during the conference session, a specific mention of a user (e.g., an “@mention”), a specific mention of a team, a file or a display screen that is shared (e.g., a document, a presentation, a spreadsheet, a video, a web page, etc.), a task that is assigned, a link to an external object that is shared, media (e.g., video) injected into a recording of the conference session, an explicit flag or tag added to the transcript by a user to mark and/or describe an important moment, recognition that a particular voice begins to speak, or any other activity determined to provide value or contribute to understanding a context of the conference session.

In various examples, the system can detect an occurrence of a notable event in a chat conversation conducted in accordance with a conference session. This enables users to submit comments, replies to comments, share files, share reactions or expressions (e.g., emojis), links to external objects (e.g., a URL), etc. to the chat conversation while viewing live or recorded content of a conference session and those comments, replies to comments, files, reactions or expressions, links to external objects, etc. can be timestamped and added to the transcript at a point that corresponds to a current point of content playback.

In some implementations, the types of notable events the system monitors for, detects, and/or adds to the transcript of the conference session can be defined or filtered by a user (e.g., a host of the conference session, a presenter of the conference session, etc.). Alternatively, the types of notable events the system monitors for, detects, and/or adds to the transcript of the conference session can be default types of notable events for a type of conference session and/or based on a number of participants in the conference session (e.g., valuable activity for a “broadcast” conference session with an audience of hundreds or thousands of people may likely be different than valuable activity for a “collaboration” conference session in which ten people are discussing and editing a work product).

Consequently, the transcript can be used as a tool to capture not only the words and/or phrases spoken by one or more persons during a conference session, but also the activity that occurs in the conference session. The information that describes a notable event in a marker of the transcript can include an icon that depicts a type of the notable event (e.g., a type of reaction, a person joining, a person leaving, a document being shared, etc.) as well as participant identification information (e.g., a picture, an avatar, a name, user initials, etc.) so a viewer knows a source of the activity (e.g., who reacted, who joined, who left, who submitted a comment, who shared a file, etc.).

In this way, the transcript can be displayed in a graphical user interface along with (e.g., next to) the content of the conference session. The transcript can be displayed while a participant is viewing the content of the conference session live as it is initially being conducted and recorded (e.g., a “live” viewing of live content). Alternatively, the transcript can be displayed while a participant is viewing the content of the conference session via a recording (e.g., a “recorded” viewing of the previously recorded content). In various examples, the transcript is configured to distinguish between notable events (e.g., markers) detected and added to the transcript during a live viewing and notable events detected and added to the transcript during a recorded viewing.

As described herein, the system is configured to analyze the transcript to determine an activity hotspot. An activity hotspot occurs when a threshold number of notable events (e.g., five, ten, fifty, one hundred, one thousand, etc.) occur within a threshold time period (e.g., ten seconds, thirty seconds, one minute, etc.). In various examples, the thresholds can be established relative to a number of participants in a conference session and/or a duration of a conference session (e.g., a scheduled duration). Based on the threshold number of notable events occurring within the threshold time period, the system can add a representation of an activity hotspot to an interactive timeline associated with the conference session. The interactive timeline is a tool that enables a user to view activity associated with a conference session. The interactive timeline can be displayed in association with content of the conference session and/or the transcript. The interactive timeline includes representations (e.g., symbols, icons, nodes, thumbnails, etc.) of the activity, and the user is able to interact with individual representations on the interactive timeline to access and/or view information associated with the activity (e.g., so the user can better understand the context of the activity). The interactive timeline can represent a duration or a scheduled duration of the conference session, and thus, each representation on the interactive timeline can also be associated with a timestamp, or a time period, based on when the activity occurs within the conference session (e.g., with respect to a point of playback of the content of the conference session). In some examples, an activity hotspot can generally represent different types of activity (e.g., a concentrated time period of different types of notable events). In other examples, the system is configured to analyze the transcript to determine that the threshold number of notable events that occur within the threshold time period are related and/or of a particular type (e.g., audience reactions regardless of a sub-type of reaction, a specific sub-type of audience reaction such as a “like” or a “dislike”, a document edit, comments submitted in association with a question & answer period in the conference session, people leaving the conference session, people joining the conference session, etc.). Accordingly, the representation of the activity hotspot added to the interactive timeline can indicate burst activity of a particular type of notable event.

In various examples, the system is configured to search the transcript for a notable event and/or for an activity hotspot. For example, the system can receive a search parameter that defines a notable event (e.g., a document with “Filename” that is shared, a “like” sentiment, etc.), and in response, the system can search for the document and/or moments when one or more persons “like” the content being presented. Upon finding associated markers in the transcript, the system can surface the markers based on the search so a user can effectively and efficiently locate the notable events being searched for.

In further examples, the system can translate the transcript from a first language (e.g., in which the conference session is conducted) to a second language based on a user selection of a second language. In addition to translating the transcript, the system is configured to translate other aspects of the conference session experience based on the user selection of the second language. For instance, the system can translate a summary of an activity hotspot representation on the interactive timeline.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which a system can generate a transcript associated with a conference session and cause the transcript to be displayed via a client computing device.

FIG. 2 is a diagram illustrating example components of an example device configured to generate a transcript associated with a conference session and cause the transcript to be displayed.

FIG. 3 illustrates an example graphical user interface configured to display a transcript associated with live or recorded content of a conference session.

FIG. 4A illustrates an example graphical user interface configured to display a transcript associated with live or recorded content and markers that describe a type of notable event in which a reaction is provided by different participants.

FIG. 4B illustrates an example graphical user interface configured to display a menu of possible reaction options that enables a participant to provide a reaction.

FIG. 4C illustrates an example graphical user interface configured to display a string of reactions over the content of the conference session being played back.

FIG. 5 illustrates an example graphical user interface configured to display a transcript associated with live or recorded content and markers that describe types of notable events other than a reaction.

FIG. 6 illustrates an example graphical user interface that represents an activity hotspot on an interactive timeline.

FIG. 7 illustrates an example graphical user interface that illustrates a search parameter used to locate notable events and/or activity hotspots in a transcript and/or on an interactive timeline.

FIG. 8 illustrates an example graphical user interface configured to display a summary of an activity hotspot representation on an interactive timeline based on user input (e.g., a hover input over the activity hotspot representation, a user click on the activity hotspot representation, etc.).

FIG. 9A illustrates an example graphical user interface that enables a user to view an activity graph associated with the activity that occurs in a transcript and/or that is represented via an interactive timeline.

FIG. 9B illustrates an example graphical user interface that displays the activity graph.

FIG. 10A illustrates an example graphical user interface that enables a user to view a translation of a transcript.

FIG. 10B illustrates an example graphical user interface that displays the translated transcript in a second language.

FIG. 11 is a diagram of an example flowchart that illustrates operations directed to generating a transcript and using the transcript to determine burst activity and/or an activity hotspot.

FIG. 12 is a diagram of an example flowchart that illustrates operations directed to translating a transcript and other aspects of a conference session.

### DETAILED DESCRIPTION

Examples described herein provide a system configured to generate and/or display a transcript associated with a conference session. The transcript can include text reflecting words spoken during the conference session and markers that describe activity that occurs in the conference session. The transcript can be used to determine an activity hotspot (e.g., bursts of activity) so that a user can efficiently and effectively locate a time in the conference session where engagement among participants is strongest. For example, via the transcript (e.g., a search parameter), a user can locate a moment when a general audience sentiment was “happy” or the audience generally “liked” what was spoken or what was presented during a conference session.

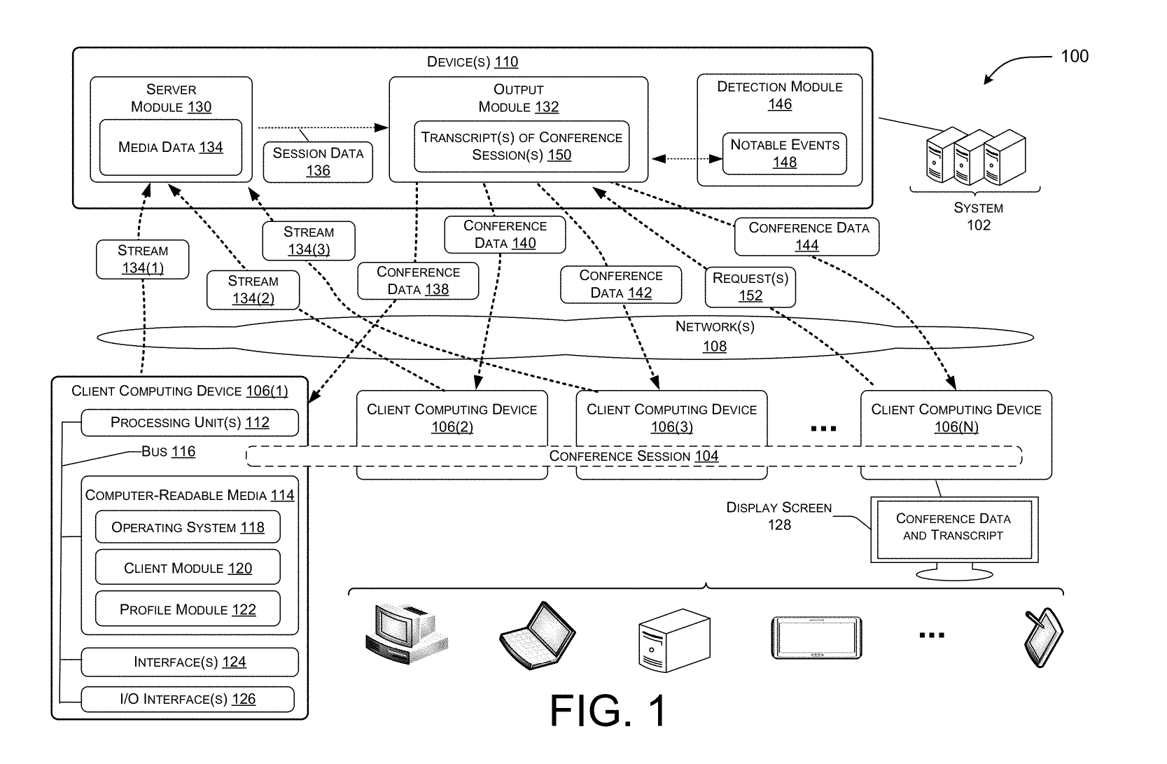

Various examples, implementations, scenarios, and aspects are described below with reference to FIGS. 1 through 12.

FIG. 1 is a diagram illustrating an example environment 100 in which a system 102 can operate to generate a transcript associated with a conference session 104 and cause the transcript to be displayed via a client computing device. The conference session 104 is being implemented between a number of client computing devices 106(1) through 106(N) (where N is a positive integer number having a value of two or greater). Note that in some examples (e.g., a broadcast scenario), the number N can include hundreds, thousands, or even millions of devices. The client computing devices 106(1) through 106(N) enable users to participate in the conference session 104 (e.g., via a “live” viewing or a “recorded” viewing). In this example, the conference session 104 is hosted, over one or more network(s) 108, by the system 102. That is, the system 102 can provide a service that enables users of the client computing devices 106(1) through 106(N) to participate in the conference session 104. Consequently, a “participant” to the conference session 104 can comprise a user and/or a client computing device (e.g., multiple users may be in a conference room participating in a conference session via the use of a single client computing device), each of which can communicate with other participants. As an alternative, the conference session 104 can be hosted by one of the client computing devices 106(1) through 106(N) utilizing peer-to-peer technologies.

In examples described herein, client computing devices 106(1) through 106(N) participating in the conference session 104 are configured to receive and render for display, on a user interface of a display screen, conference data. The conference data can comprise one instance or a collection of various instances, or streams, of content (e.g., live or recorded content). For example, an individual stream of content can comprise media data associated with a video feed (e.g., audio and visual data that capture the appearance and speech of a user participating in the conference session). Another example of an individual stream of content can comprise media data that includes an avatar of a user participating in the conference session along with audio data that captures the speech of the user. Yet another example of an individual stream of content can comprise media data that includes a file displayed on a display screen and/or audio data that captures the speech of a user. Accordingly, the various streams of content within the conference data enable a remote meeting to be facilitated between a group of people and the sharing of content within the group of people.

The system 102 includes device(s) 110. The device(s) 110 and/or other components of the system 102 can include distributed computing resources that communicate with one another and/or with the client computing devices 106(1) through 106(N) via the one or more network(s) 108. In some examples, the system 102 may be an independent system that is tasked with managing aspects of one or more conference sessions such as conference session 104. As an example, the system 102 may be managed by entities such as SLACK, WEBEX, GOTOMEETING, GOOGLE HANGOUTS, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, a profile module 122, and other modules, programs, or applications that are loadable and executable by processing units(s) 112.

Client computing device(s) 106(1) through 106(N) may also include one or more interface(s) 124 to enable communications between client computing device(s) 106(1) through 106(N) and other networked devices, such as device(s) 110, over network(s) 108. Such network interface(s) 124 may include one or more network interface controllers (NICs) or other types of transceiver devices to send and receive communications and/or data over a network. Moreover, client computing device(s) 106(1) through 106(N) can include input/output (“I/O”) interfaces 126 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 1 illustrates that client computing device 106(N) is in some way connected to a display device (e.g., a display screen 128), which can display the conference data and/or a transcript for a conference session.

In the example environment 100 of FIG. 1, client computing devices 106(1) through 106(N) may use their respective client modules 120 to connect with one another and/or other external device(s) in order to participate in the conference session 104. For instance, a first user may utilize a client computing device 106(1) to communicate with a second user of another client computing device 106(2). When executing client modules 120, the users may share data, which may cause the client computing device 106(1) to connect to the system 102 and/or the other client computing devices 106(2) through 106(N) over the network(s) 108.

The client computing device(s) 106(1) through 106(N) may use their respective profile module 122 to generate participant profiles, and provide the participant profiles to other client computing devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for conference sessions.

As shown in FIG. 1, the device(s) 110 of the system 102 includes a server module 130 and an output module 132. The server module 130 is configured to receive, from individual client computing devices such as client computing devices 106(1) through 106(3), media streams 134(1) through 134(3). As described above, media streams can comprise a video feed (e.g., audio and visual data associated with a user), audio data which is to be output with a presentation of an avatar of a user (e.g., an audio only experience in which video data of the user is not transmitted), file data and/or screen sharing data (e.g., a document, a slide deck, an image, a video displayed on a display screen, etc.), and so forth. Thus, the server module 130 is configured to receive a collection of various media streams 134(1) through 134(3) (the collection being referred to herein as media data 134). In some scenarios, not all the client computing devices that participate in the conference session 104 provide a media stream. For example, a client computing device may only be a consuming, or a “listening”, device such that it only receives content associated with the conference session 104 but does not provide any content to the conference session 104.

The server module 130 is configured to generate session data 136 based on the media data 134. In various examples, the server module 130 can select aspects of the media data 134 that are to be shared with the participating client computing devices 106(1) through 106(N). Consequently, the server module 130 is configured to pass the session data 136 to the output module 132 and the output module 132 may communicate conference data to the client computing devices 106(1) through 106(N). As shown, the output module 132 transmits conference data 138 to client computing device 106(1), transmits conference data 140 to client computing device 106(2), transmits conference data 142 to client computing device 106(3), and transmits conference data 144 to client computing device 106(N). The conference data transmitted to the client computing devices can be the same or can be different (e.g., streams and/or the positioning of streams of content within a view of the user interface may vary from one device to the next). The output module 132 can also be configured to record conference sessions (e.g., a version of the conference data) and/or to maintain recordings of the conference sessions.

The device(s) 110 can also include a detection module 146 configured to detect occurrences of notable events 148 (e.g., activity) in the session data 136 of a conference session. For instance, a notable event 148 can occur as a live viewing of a conference session is progressing such that activity that amounts to a notable event by users of client computing devices 106(1) through 106(3) that are participating via the live viewing can be detected and/or added to a transcript of the conference session 150. Alternatively, a notable event 148 can occur during a recorded viewing of the conference session (e.g., client computing device 106(N) can send a request 152 to view a recording of the conference session, and thus the conference data 144 provided to client computing device 106(N) can include recorded content).

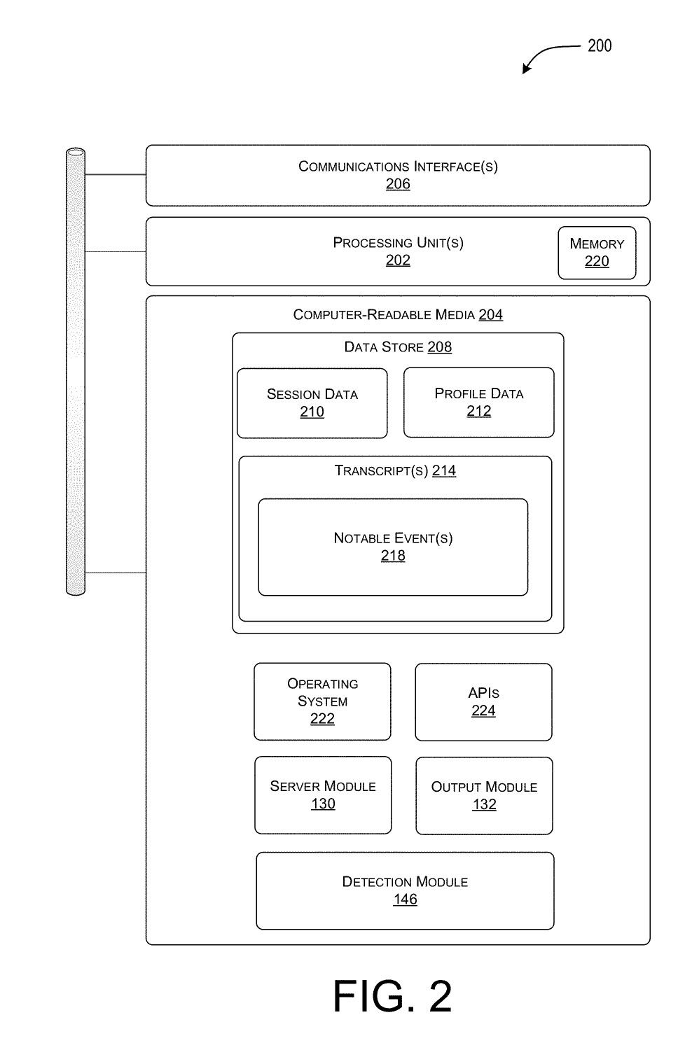

FIG. 2 is a diagram illustrating example components of an example device 200 configured to generate a transcript associated with a conference session 104 and cause the transcript to be displayed via a client computing device. The device 200 may represent one of device(s) 110, or in other examples a client computing device, where the device 200 includes one or more processing unit(s) 202, computer-readable media 204, and communication interface(s) 206. The components of the device 200 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network.

In the illustrated example, computer-readable media 204 includes a data store 208. In some examples, data store 208 includes data storage such as a database, data warehouse, or other type of structured or unstructured data storage. In some examples, data store 208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 208 may store data for the operations of processes, applications, components, and/or modules stored in computer-readable media 204 and/or executed by processing unit(s) 202. For instance, in some examples, data store 208 may store session data 210 (e.g., session data 136), profile data 212 (e.g., associated with a participant profile), and/or other data. The session data 210 can include a total number of participants (e.g., users and/or client computing devices) in a conference session, activity that occurs in the conference session (e.g., notable events), and/or other data related to when and how the conference session is conducted or hosted. The data store 208 can also include transcripts 214 of conference sessions, the transcripts 214 including markers for activity that occurs in the conference sessions (e.g., notable events 218).

Alternately, some or all of the above-referenced data can be stored on separate memories 220 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes operating system 222 and application programming interface(s) 224 configured to expose the functionality and the data of the device 200 to other devices. Additionally, the computer-readable media 204 can include one or more modules such as the server module 130, the output module 132, and the detection module 146, although the number of illustrated modules is just an example, and the number may vary higher or lower. That is, functionality described herein in association with the illustrated modules may be performed by a fewer number of modules or a larger number of modules on one device or spread across multiple devices.

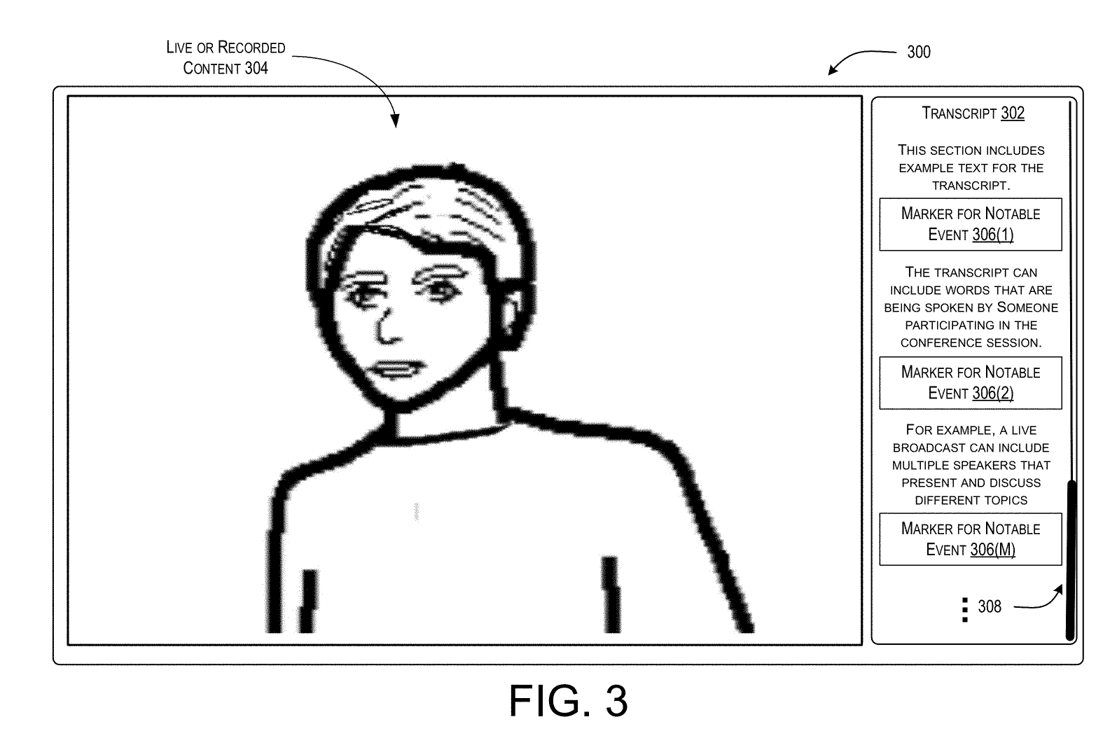

FIG. 3 illustrates an example graphical user interface 300 configured to display a transcript 302 associated with live or recorded content 304. In this example, the live or recorded content 304 illustrates a view in which an individual person is speaking (e.g., a presenter on a stage that is speaking to a large audience, a team leader informing his or her team of new procedures, etc.). However, other views of content can be implemented in association with the techniques and examples described herein. A “view” comprises a configuration and/or a layout of content of the conference session. For example, a grid view can include two or more persons speaking in separate cells on a graphical user interface (e.g., a quad cell configuration). Moreover, as described above, file content can be displayed rather than a video feed of a person. Consequently, content of a conference session can be displayed in multiple different views.

The transcript 302 can include text reflecting words spoken during the conference session. As described above, a portion or snippet of the text can be associated with a timestamp that indicates when the text was spoken with respect to a point of playback of the live or recorded content 304. The transcript 302 can also include markers 306(1) through 306(M) (where M is a positive integer number) that describe notable events that occur in the conference session. The detection module 146 is configured to detect the notable events and add the markers 306(1) through 306(M) to the transcript. Alternatively, a marker can be manually added to the transcript (e.g., by a host or conductor of the conference session). The markers 306(1) through 306(M) can also be associated with a timestamp that indicates when the activity occurs with respect to a point of playback of the live or recorded content 304. The markers 306(1) through 306(M) can be interspersed within the text based on a time of occurrence with respect to the live or recorded content 304 being played back.

The transcript 302 is populated with the text and/or markers 306(1) through 306(M) as the words are spoken and as the activity occurs. Thus, as new material is added, older material may be pushed up and off the graphical user interface 300. To enable a viewer to look back and locate text and/or markers that previously occurred, the transcript 302 can be a scrollable transcript via the use of a scroll bar 308.

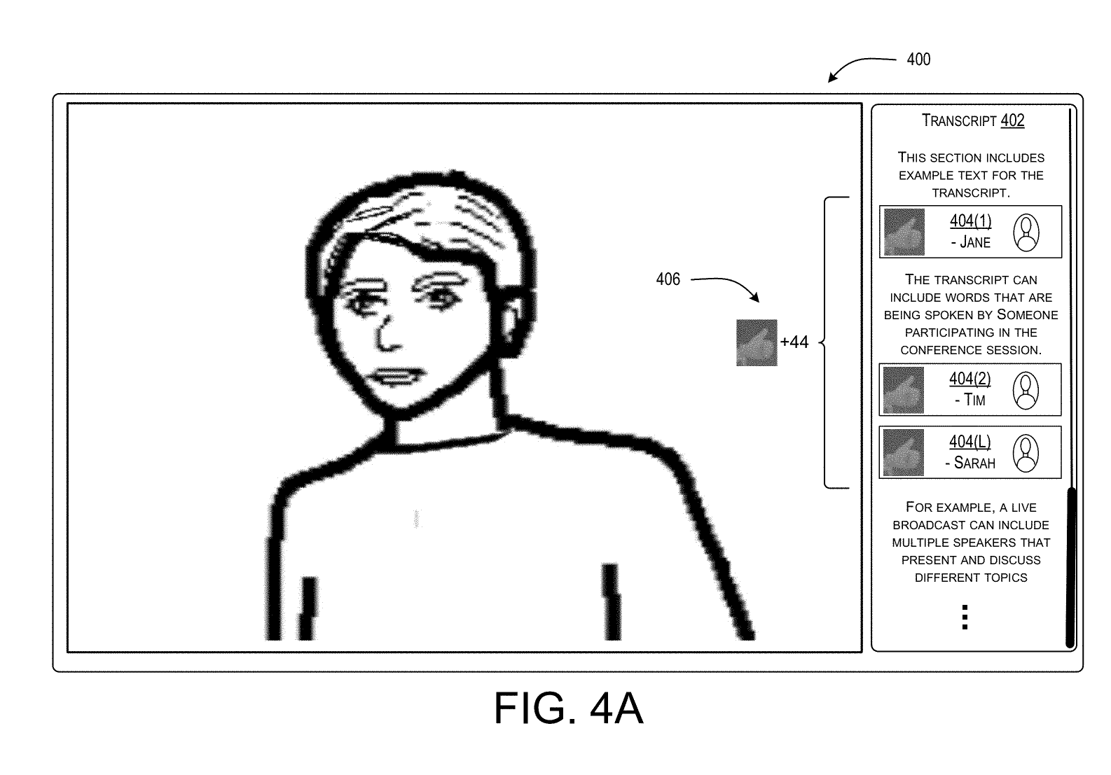

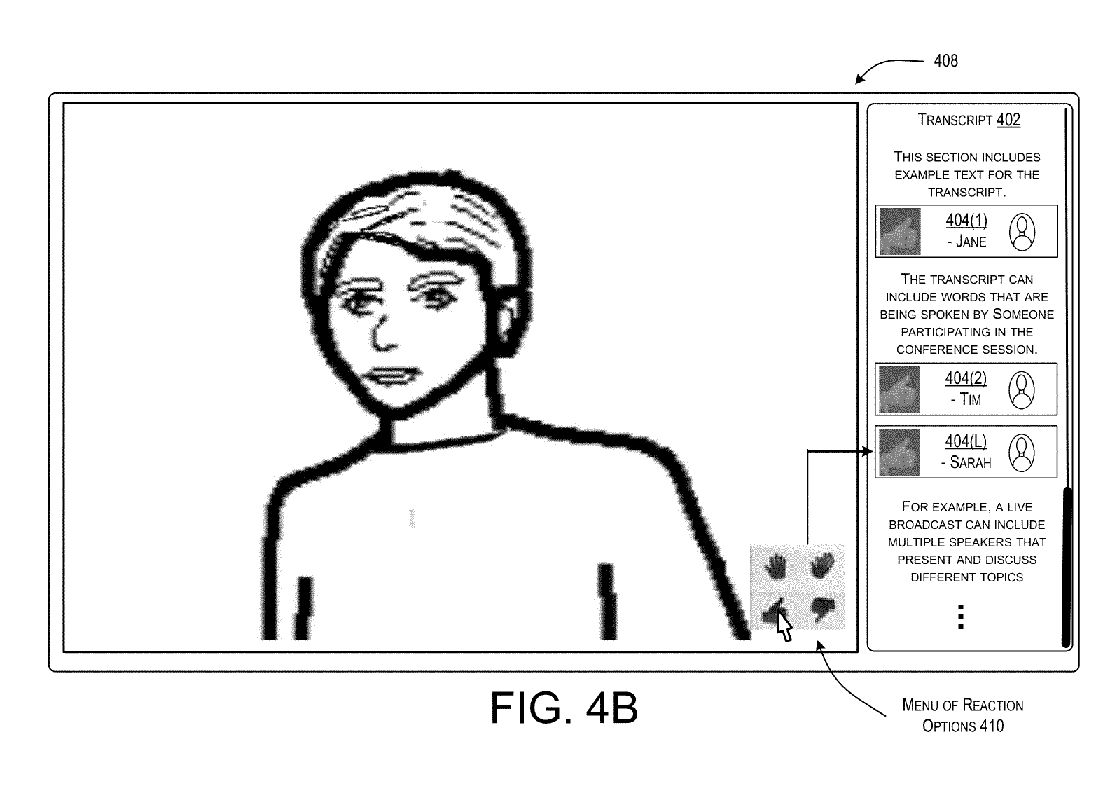

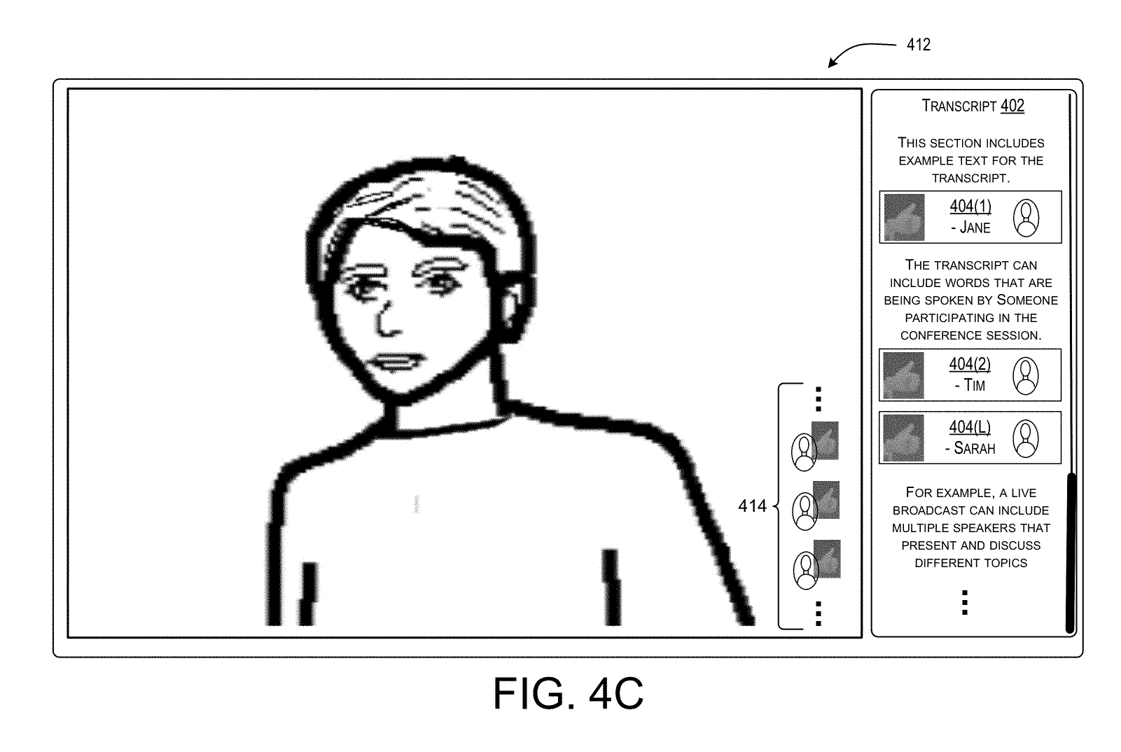

FIG. 4A illustrates an example graphical user interface 400 configured to display a transcript 402 associated with live or recorded content and markers 404(1) through 404(L) (where L is a positive integer number) that describe a type of notable event in which a reaction is provided by different participants. More specifically, the markers 404(1) through 404(L) describe that the sub-type of a broader reaction type of notable event includes a “like” sentiment.

As described above, the information in a marker that describes a notable event can include an icon that depicts a type of the notable event as well as participant identification information (e.g., a picture, an avatar, a name, user initials, etc.) so a viewer knows a source of the activity. In this example, marker 404(1) includes a “thumbs-up” icon to describe that Jane “liked” what was being said or what was being presented at a particular point or moment in time (e.g., the marker can also include an avatar of Jane). Marker 404(2) includes a “thumbs-up” icon to describe that Tim “liked” what was being said or what was being presented at a particular point or moment in time (e.g., the marker can also include an avatar of Tim). And marker 404(L) includes a “thumbs-up” icon to describe that Sarah “liked” what was being said or what was being presented at a particular point or moment in time (e.g., the marker can also include an avatar of Sarah).

In various examples, the detection module 146 is configured to determine that a threshold number (e.g., five, ten, twenty, one hundred, etc.) of notable events (e.g., a reaction such as the “likes” in FIG. 4A) occur within a threshold period of time (e.g., five seconds, ten seconds, thirty seconds, a minute, etc.). Based on this determination, a “burst” activity representation 406 of a number of notable events that exceeds the threshold can be generated and displayed in association with the transcript 402. The burst activity representation 406 can indicate a number of notable events and/or a type of notable event (e.g. forty-four people “liked” the content within the threshold period of time). The burst activity representation 406 can be displayed instead of markers 404(1) through 404(L) to conserve display space within the transcript 402, or the burst activity representation 406 can be displayed outside the transcript 402 and in addition to the markers 404(1) through 404(L). In some examples, an individual marker within the transcript 402 can describe the burst activity (e.g., forty-four people “liked” what was being said by the speaker at this point or moment in the conference session). While the burst activity shown in FIG. 4A illustrates a “like” reaction, other types of burst activity can be represented such as other sub-types of a broader reaction type. For example, a burst join representation can represent when a threshold number of people join the conference session. In another example, a burst leave representation can represent when a threshold number of people leave the conference session. In yet another example, a burst vote representation can represent when a threshold number of people vote in response to a poll conducted in the conference session.

In various examples, a geographic location of a device (e.g., an end-user) that is a source of a notable event (e.g., the provision of a reaction) can be provided and/or obtained. Consequently, a presenter in a broadcast presentation can be made aware that a strong audience reaction is based on a particular geographic region (e.g., employees that live in a particular city may have liked the mentioning of their city). A geographic region can be a variety of different sizes and/or be defined in different ways (e.g., different rooms or floors in a building, different buildings on a campus, a neighborhood community, a zip code, a city, a county, a state, a country, a continent, etc.). The geographic location can be based on an IP address, a GPS signal, or other device and/or networking location and positioning techniques. Further, a reaction map can be generated and/or presented, the reaction map illustrating type(s) of audience reaction(s) that originate in different geographic regions. The presenter, or a host of a session, can determine to share the geographic location information associated with the audience reactions to all the viewers (e.g., a first geographic region may have liked what was said while a second geographic region may have not liked what was said).

FIG. 4B illustrates an example graphical user interface 408 configured to display a menu of possible reaction options 410 that enables a participant to provide a reaction. The menu of possible reaction options 410 can be displayed to the participant in any area of the graphical user interface 408. The menu of possible reaction options 410 can be activated and displayed in response to a command or the menu of possible reaction options 410 can be persistently displayed as the content of the conference session is played back. As shown as an example, the menu of possible reaction options 410 includes a “like” reaction (e.g., the “thumbs up” icon), a “dislike” reaction (e.g., the “thumbs down” icon), an “applause” reaction (e.g., the “clapping” icon), and a “high five” reaction (e.g., the “raised hand” icon). The participant (e.g., Sarah) selects the thumbs up icon using a user control element (e.g., a mouse cursor) and the notable event is detected and added to the transcript 402 via marker 404(L), as shown via the arrow. Other possible menu options can include emojis (e.g., smiley face, angry face, laughing face, crying face, etc.) or other icons and text use to reflect user sentiment and/or user expression.

FIG. 4C illustrates an example graphical user interface 412 configured to display a string of reactions 414 over the live or recorded content of the conference session being played back. The string of reactions can be used in addition to or as an alternative to the markers 404(1) through 404(L) in the transcript 402. The string of reactions 414 provides an effective way of showing a viewer participant reaction outside the transcript 402. Thus, the string of reactions 414 includes instances of a reaction and an avatar associated with a participant that provides the reaction. An individual instance can be temporarily displayed based on a number of instances to display and/or a temporal proximity to the live or recorded content a participant liked.

In various examples, the string of reactions 414 can indicate video reactions provided directly on top of the live or recorded content being played back (e.g., the menu 410 in FIG. 4B can be associated with video input), while the markers 404(1) through 404(L) can represent and describe chat reactions provided via a chat conversation associated with the conference session.

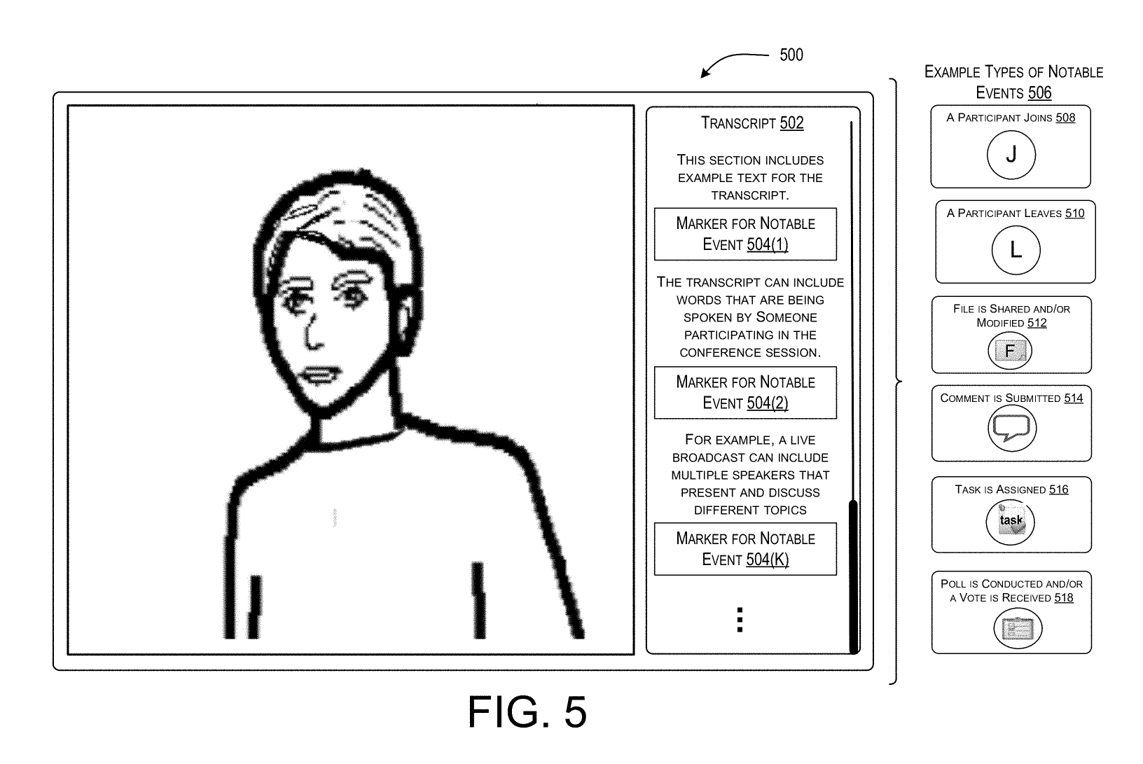

FIG. 5 illustrates an example graphical user interface 500 configured to display a transcript 502 associated with live or recorded content and markers 504(1) through 504(K) (where K is a positive integer number) that describe types of notable events other than a reaction. In this example, individual ones of the markers 504(1) through 504(K) can be associated with one of the example types of notable events 506. A first example type of notable event illustrated in FIG. 5 can comprise a participant joining the conference session 508. Thus, a “join” or “J” icon can be displayed in the transcript 502 and/or as a temporary pop up indicator over the live or recorded content (e.g., in a string of indicators similar to the string of reactions 414 in FIG. 4C) along with participant identification information (e.g., an avatar, a name, initials, etc.). A second example type of notable event can comprise a participant leaving the conference session 510. Thus, a “leave” or “L” icon can be displayed in the transcript 502 and/or as a temporary pop up indicator over the live or recorded content along with participant identification information. A third example type of notable event can comprise a file being shared and/or displayed file content being modified (e.g., edited, page flip, slide change, etc.) in the conference session 512. Thus, a “file” or “F” icon can be displayed in the transcript 502 and/or as a temporary pop up indicator over the live or recorded content along with (i) a description of the file and/or the modification and (ii) participant identification information. A fourth example type of notable event can comprise a comment being submitted to a chat conversation associated with the conference session 514. Thus, a “comment” icon can be displayed in the transcript 502 and/or as a temporary pop up indicator over the live or recorded content along with (i) the comment or message and (ii) participant identification information. A fifth example type of notable event can comprise a task being assigned in the conference session 516. Thus, a “task” icon can be displayed in the transcript 502 and/or as a temporary pop up indicator over the live or recorded content along with (i) a description of the task and (ii) participant identification information. A sixth example type of notable event can comprise a poll being conducted and/or a vote being submitted in the conference session 518. Thus, a “poll” or a “vote” icon can be displayed in the transcript 502 and/or as a temporary pop up indicator over the live or recorded content along with (i) the poll and/or the vote and (ii) participant identification information. In some instances where the example types of notable events (e.g., a poll and/or a vote) includes sensitive or private subject matter, a marker in the transcript 502 may not include participant identification information.

The types of notable events 506 illustrated in FIG. 5 are provided herein as examples for illustrative purposes. Thus, other types of notable events are also contemplated, occurrences of which provide value and contribute to an understanding of a context of what has happened in a conference session.

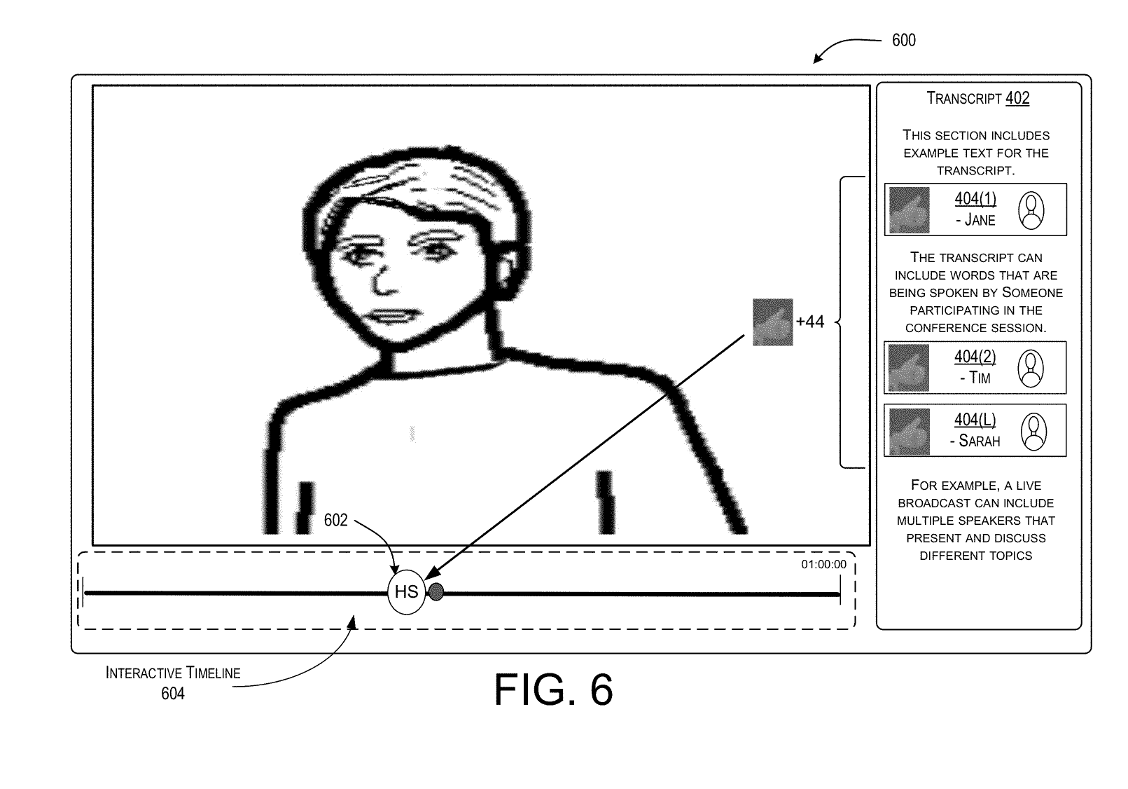

FIG. 6 illustrates an example graphical user interface 600 that represents an activity hotspot 602 on an interactive timeline 604. As described above with respect to FIG. 4A (e.g., elements of which are used here in FIG. 6), the detection module 146 is configured to analyze the transcript 402 to determine when a threshold number of notable events (e.g., five, ten, fifty, one hundred, one thousand, etc.) occur within a threshold time period (e.g., five seconds, ten seconds, thirty seconds, one minute, etc.). This may be referred to as an activity hotspot and/or burst activity. As shown in FIG. 6, forty-four instances of a “like” reaction are detected within a threshold period of time (e.g., ten seconds).

Consequently, the detection module 146 is configured to add a representation 602 of an activity hotspot to the interactive timeline 604 associated with the conference session (e.g., the activity hotspot can be mapped to a position on the interactive timeline 604 at which the burst activity occurs with respect to the playback of the content). The interactive timeline 604 can include representations (e.g., symbols, icons, nodes, thumbnails, etc.) of individual notable events, as well as representations of activity hotspots. Moreover, a user is able to interact with individual representations on the interactive timeline 604 to access and/or view information associated with the activity (e.g., so the user can better understand the context of the activity). For example, upon clicking on the representation 602 of the activity hotspot via the interactive timeline 604, the user can quickly access a corresponding playback position of content (e.g., recorded content) to gain an understanding of reasons the increased activity occurred (e.g., what was said that caused an increased number of people to submit a like reaction, why did an increased number of people leave the conference session, why did an increased number of people submit a comment in the chat conversation, etc.).

In some examples, an activity hotspot can be placed on the interactive timeline to represent different types of notable events (e.g., a concentrated time period in which different types of notable events are detected). However, in other examples, the activity hotspot can be placed on the interactive timeline to represent an individual type of notable event (e.g., a leave, a join, submitted comments, votes submitted in response to a poll, audience reaction regardless of sub-type, etc.) or an individual sub-type of a broader reaction type of notable event (e.g., like, dislike, angry, happy, etc.). Accordingly, the representation 602 of the activity hotspot added to the interactive timeline 604 can include a label indicating a particular type of burst activity (e.g., the icons for the examples types of notable events 506 illustrated in FIG. 5).

In some examples, the types of notable events the detection module 146 monitors for, detects, and/or adds to the transcript 402 and/or the interactive timeline 604 can be defined and/or filtered by a user (e.g., a host of the conference session, a presenter of the conference session, etc.). Alternatively, the types of notable events the detection module 146 monitors for, detects, and/or adds to the transcript of the conference session can be default types of notable events based on a type of conference session and/or based on a number of participants in the conference session. For instance, valuable activity for a “broadcast” conference session with an audience of hundreds or thousands of people may likely be different than valuable activity for a “collaboration” conference session in which ten people are discussing and editing a work product.

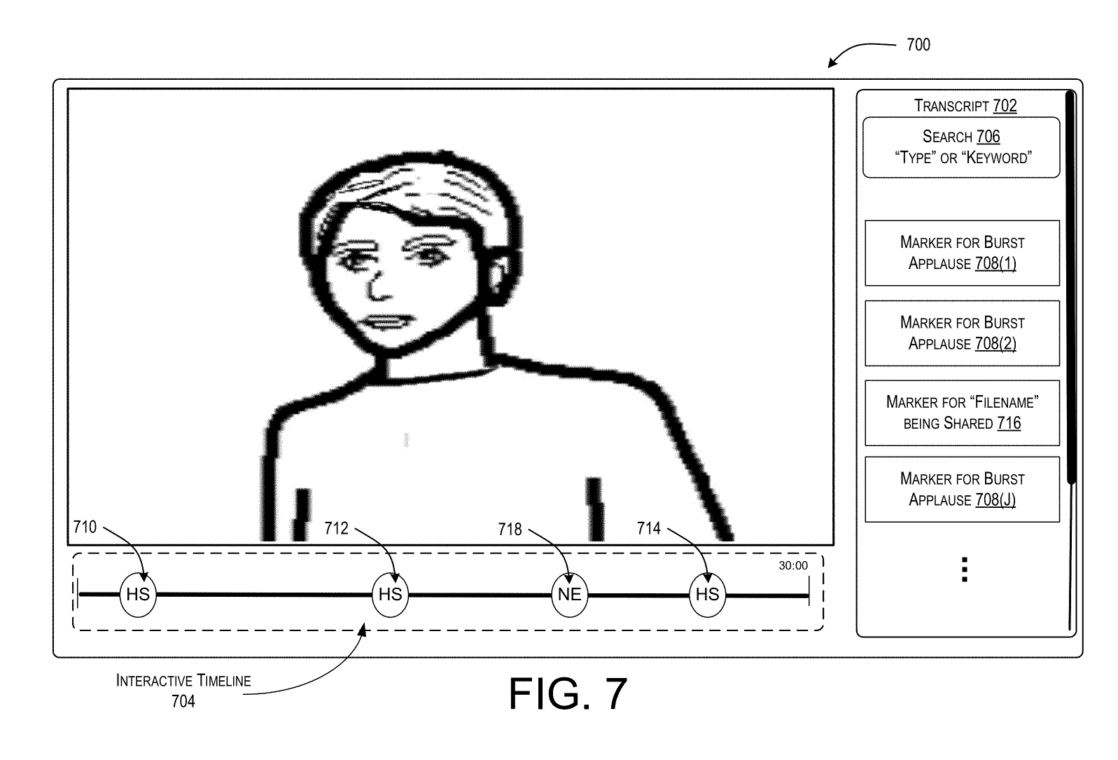

FIG. 7 illustrates an example graphical user interface 700 that illustrates a search used to locate notable events and/or activity hotspots in a transcript 702 and/or on an interactive timeline 704. FIG. 7 illustrates a search parameter 706 that defines a type of notable event or a specific notable event. For instance, a user can enter text associated with a type of notable event (e.g., “likes”, “applause”, “join”, “leave”, etc.) or keyword text associated with a specific notable event (e.g., a document with “Filename” that is shared). Based on the search parameter 706, the system can search the transcript 702 for the type of notable event and/or for the specific notable event. For example, if the user searches for “applause”, markers 708(1) through 708(J) (where J is a positive integer number) that captures burst applause activity are located and surfaced in the transcript 702. Moreover, the markers 708(1) through 708(J) can be mapped to activity hotspot representations on the interactive timeline 704 to further enhance the visual response to a search. That is, marker 708(1) can be mapped to activity hotspot representation 710, marker 708(2) can be mapped to activity hotspot representation 712, and marker 708(J) can be mapped to activity hotspot representation 714. In another example, if the user searches for “Filename”, marker 716 that captures a time when the document “Filename” is shared in the conference session is located and surfaced in the transcript 702. Moreover, the marker 716 can be mapped to a corresponding representation 718 of a notable event on the interactive timeline 704.

An individual marker 708(1) through 708(J) or 716 can be displayed with a portion (e.g., snippet) of surrounding text that captures what was being said at the time the notable event(s) occur.

In various examples, a user can submit input that causes a search of a collaboration environment to be implemented. A collaboration environment can comprise functionality and/or tools that enable a group of users to continually collaborate and interact in a social or a work setting (e.g., conferencing applications, chat applications, document sharing and storage applications, etc.). Accordingly, the system is configured to search multiple different recorded conference sessions and/or chat conversations for instances of a type of notable event and/or for instances of a specific notable event that the user desires to view, and the results can be surfaced in a transcript and/or interactive timeline that represents the collaboration environment. In this way, a use can locate the strongest audience response moments that occurred in the last month across a number of different conference sessions.

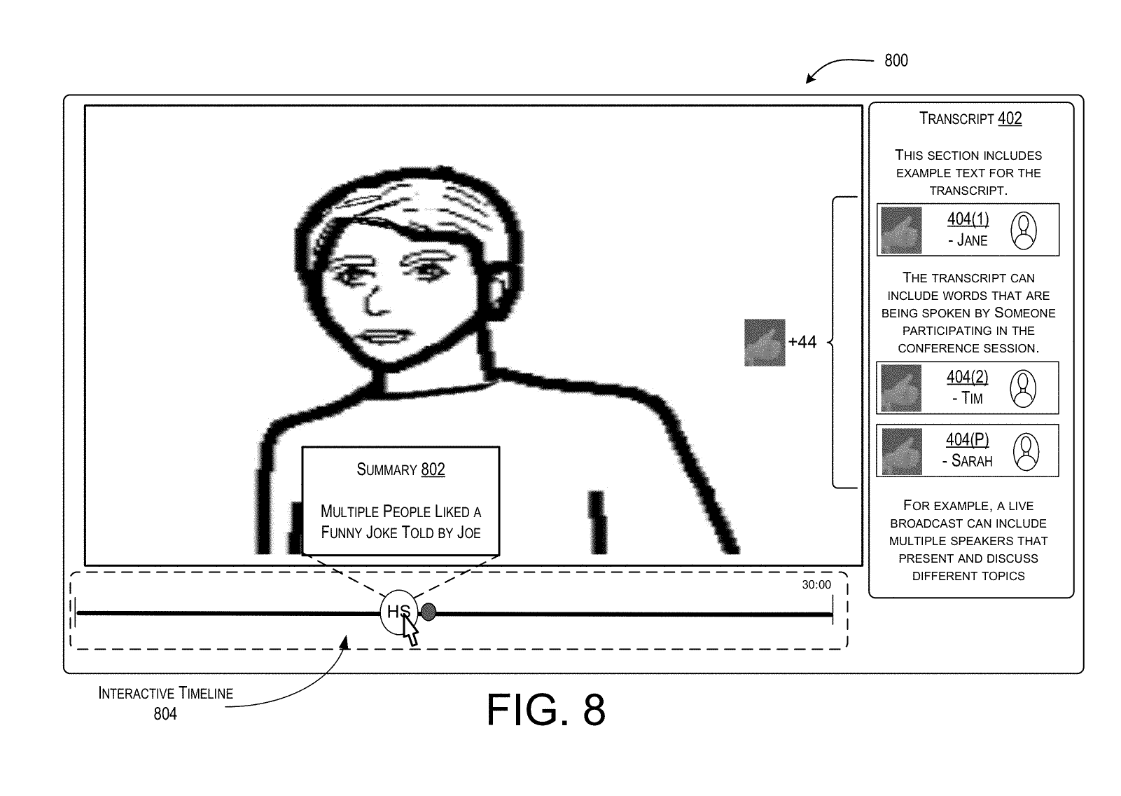

FIG. 8 illustrates an example graphical user interface 800 configured to display a summary 802 of an activity hotspot representation on an interactive timeline 804 based on user input (e.g., a hover input over the activity hotspot representation, a user click on the activity hotspot representation, etc.). As described above with respect to FIG. 4A (e.g., elements of which are used here in FIG. 6), the detection module 146 is configured to analyze the transcript 402 to determine when a threshold number of notable events (e.g., five, ten, fifty, one hundred, one thousand, etc.) occur within a threshold time period (e.g., five seconds, ten seconds, thirty seconds, one minute, etc.). This may be referred to as an activity hotspot and/or burst activity. As shown in FIG. 6, forty-four instances of a “like” reaction are detected within a threshold period of time (e.g., ten seconds).

Consequently, the detection module 146 is configured to add a representation of an activity hotspot to the interactive timeline 804 associated with the conference session (e.g., the activity hotspot can be mapped to a position on the interactive timeline 804 at which the burst activity occurs with respect to the playback of the content). Moreover, the user is able to interact with individual representations on the interactive timeline 804 to access and/or view information associated with the activity. In this example, the detection module 146 analyzes the transcript 402 to determine that the activity hotspot occurred because Joe told a funny joke, and such is displayed in the summary 802.

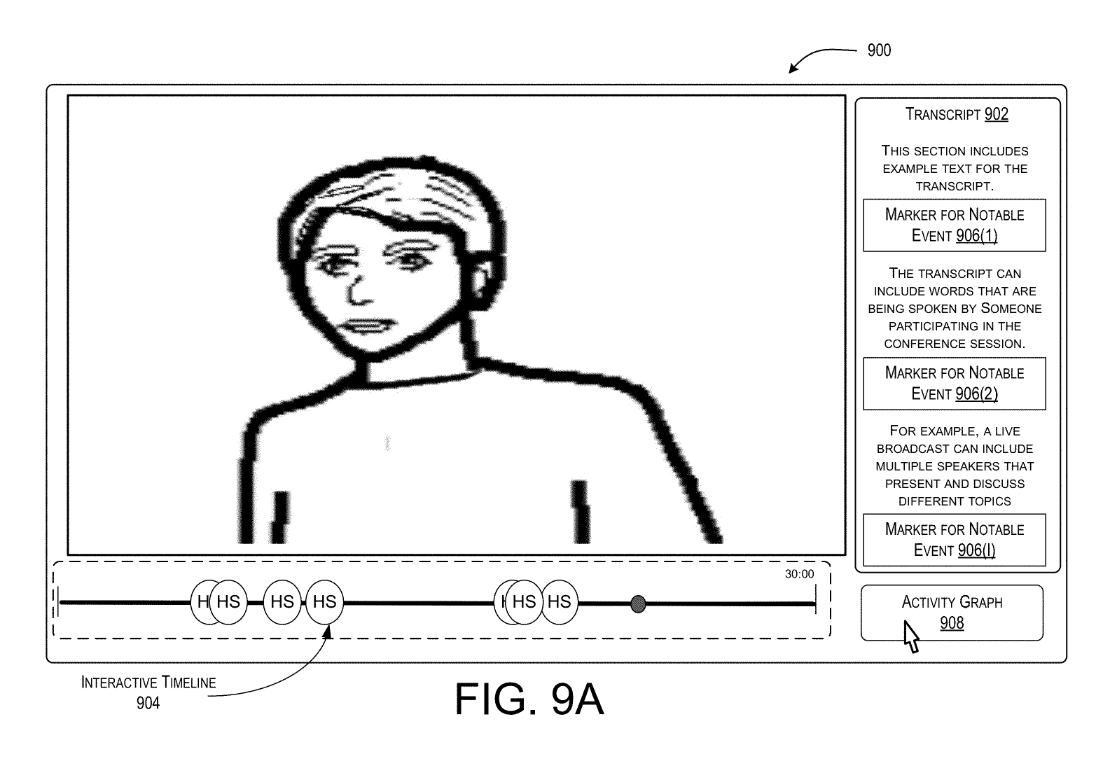

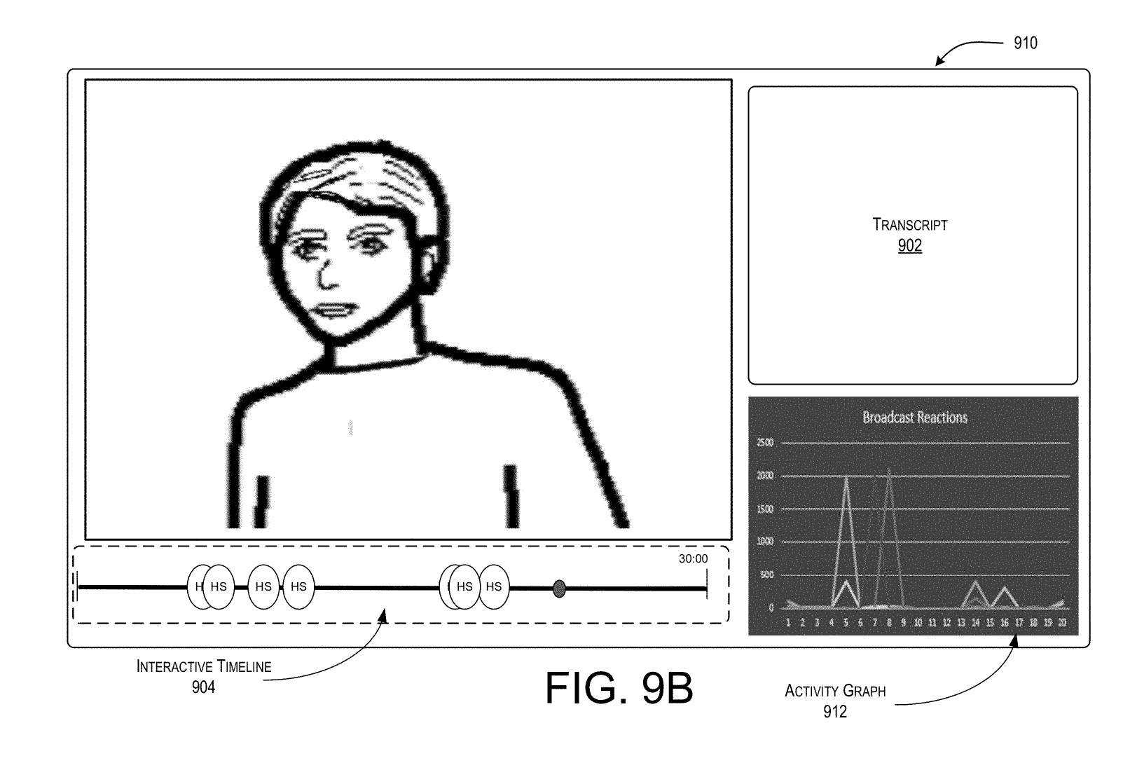

FIG. 9A illustrates an example graphical user interface 900 that enables a user to view an activity graph associated with the activity that occurs in a transcript 902 and/or that is represented via an interactive timeline 904. As described above, the interactive timeline 904 can include representations of activity hotspots based on when markers of notable events 906(1) through 906(I) (where I is a positive integer number) occur in the transcript 902. To further enhance the visual view of burst activity and activity hotspots, the example graphical user interface 900 displays an option for the user to select an activity graph 908 (e.g., a selectable user interface element).

FIG. 9B illustrates an example graphical user interface 910 that displays the activity graph 912. As shown, the layout of the graphical user interface is adjusted to display the activity graph 912, which in this example, shows spikes in “Broadcast Reactions”, the spikes representing the activity hotspots on the interactive timeline 904 (e.g., a time at which the spikes occur and a number of notable events of a particular type).

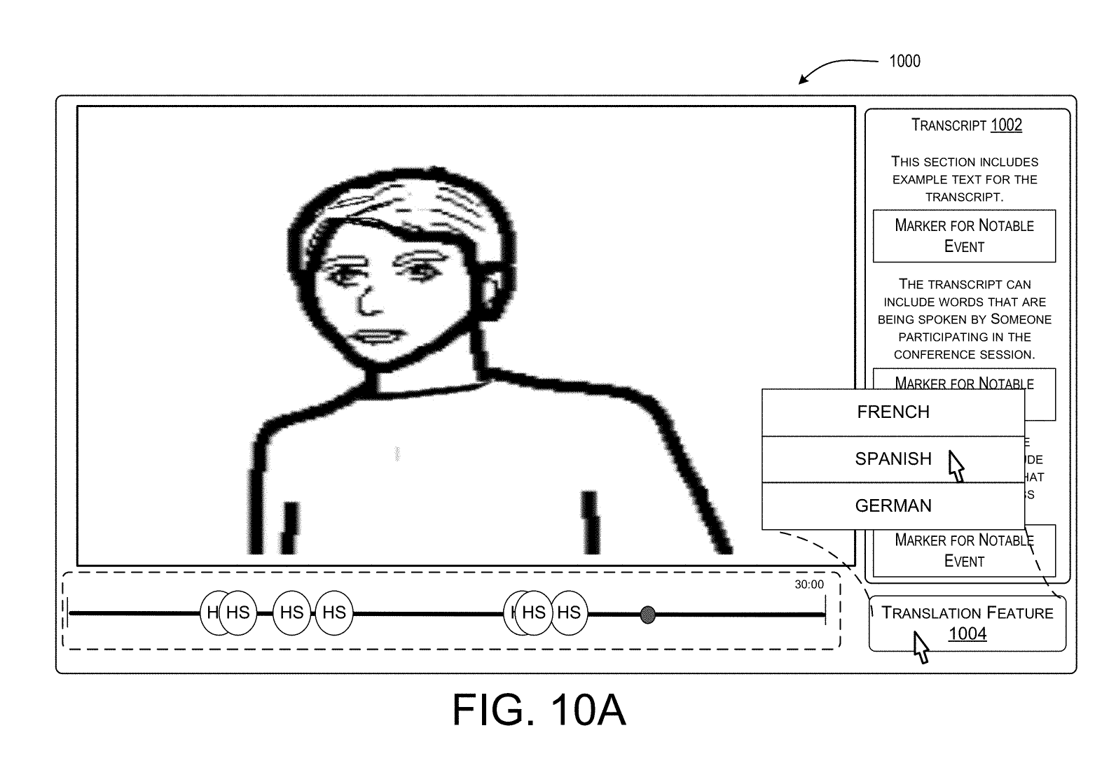

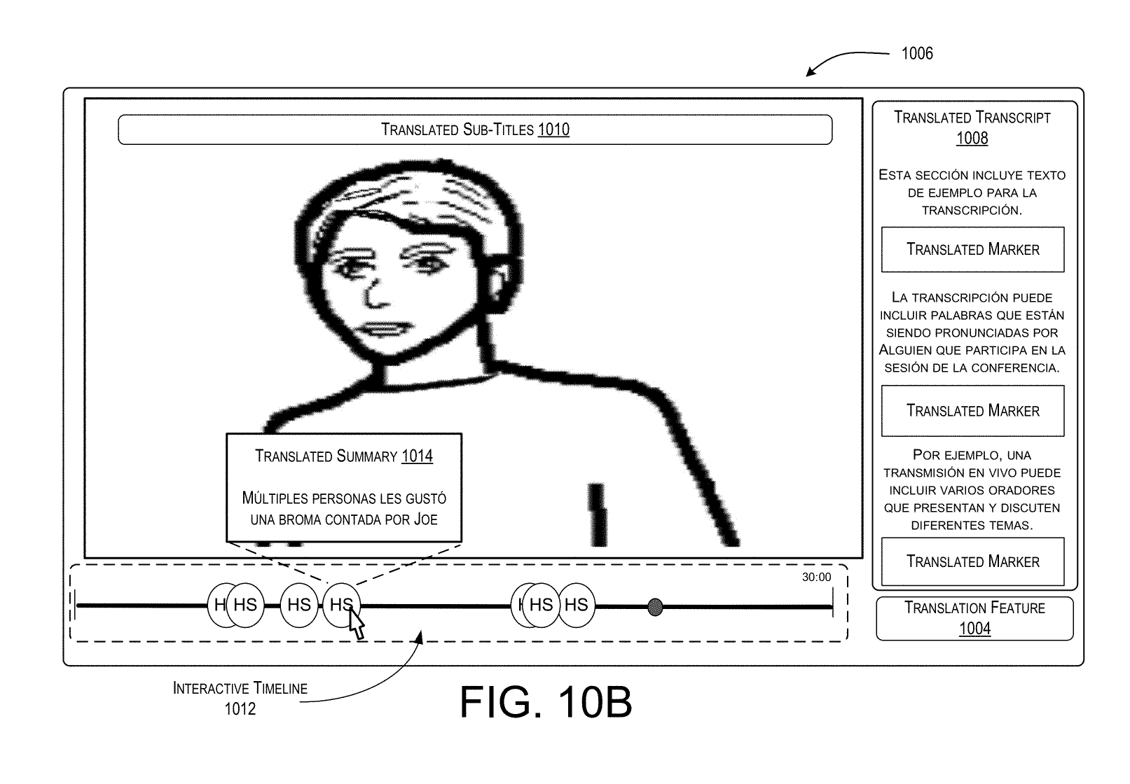

FIG. 10A illustrates an example graphical user interface 1000 that enables a user to view a translation of a transcript 1002. The example graphical user interface 1000 displays an option for the user to select a translation feature 1004 (e.g., a selectable user interface element) to have the transcript 1002 translated from a first language (e.g., English) to a second language (e.g., Spanish is selected amongst the available options).

FIG. 10B illustrates an example graphical user interface 1006 that displays the translated transcript 1008 in Spanish. Furthermore, the example graphical user interface 1006 includes translated sub-titles 1010 to reflect what the speaker is saying. This enables the user to stay focused on the speaker. Even further, the translation feature 1004 associated with the transcript 1002 is configured to translate other aspects of the conference session for the user. For example, information presented via an interactive timeline 1012 can be translated. More specifically, FIG. 10B illustrates a translated summary 1014 based on user interaction (e.g., hover input, click, etc.) with a representation of an activity hotspot.

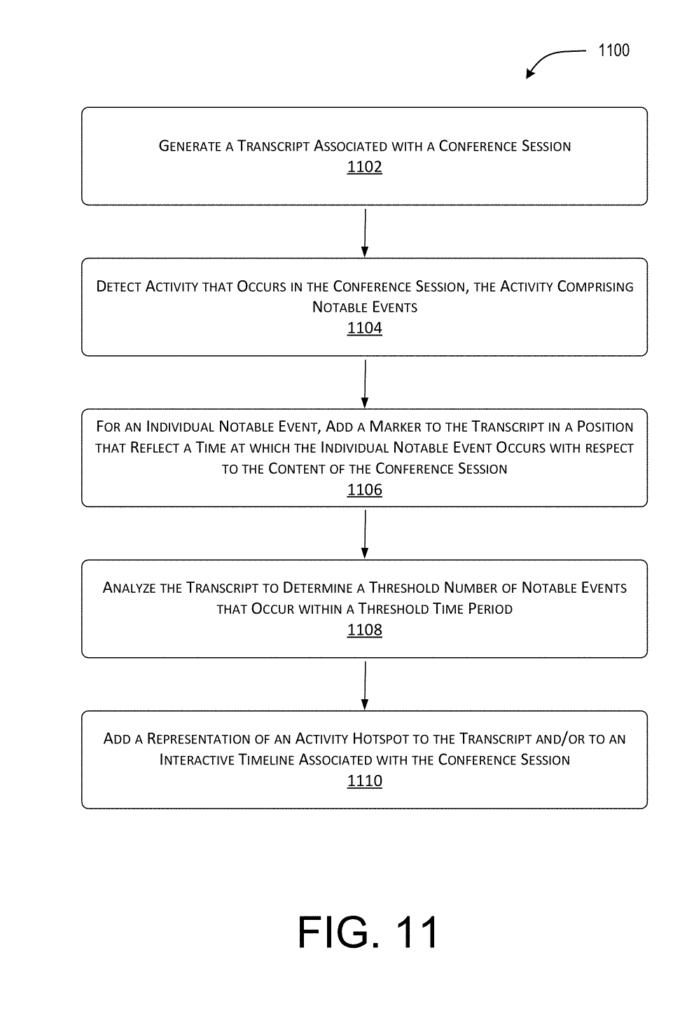

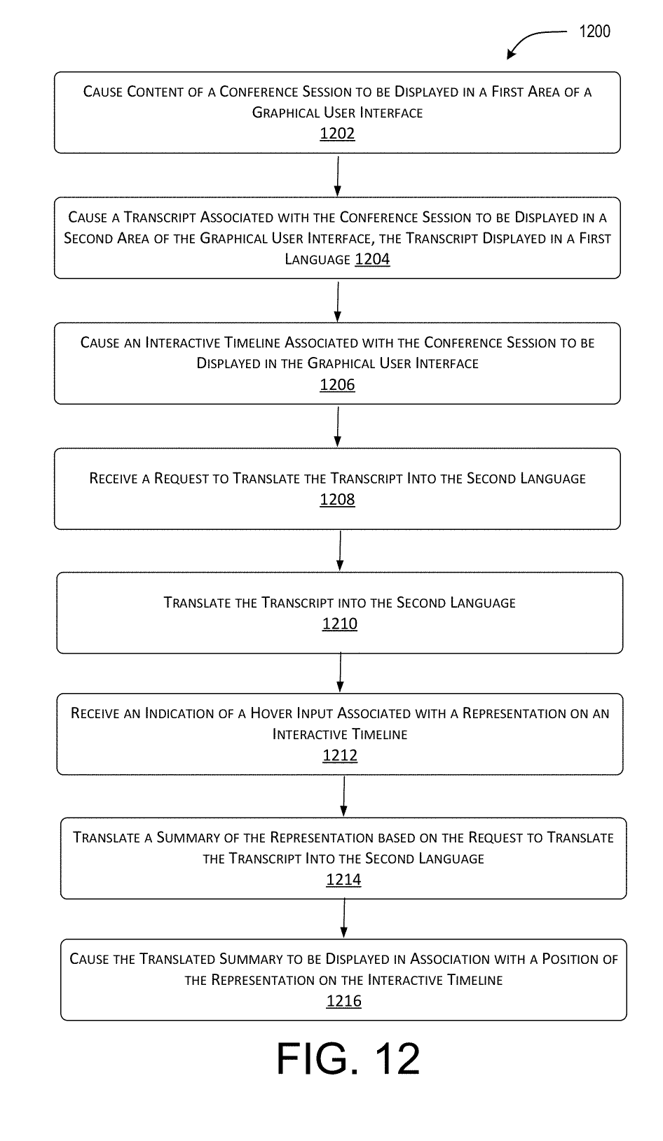

FIGS. 11 and 12 illustrate example flowcharts. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., device 110, client computing device 106(N), and/or device 200) and/or (2) as interconnected machine logic circuits or circuit modules within the computing system.

Additionally, the operations illustrated in FIGS. 11 and/or 12 can be implemented in association with the example graphical user interfaces described above with respect to FIGS. 3-10B. For instance, the various device(s) and/or module(s) in FIGS. 1 and/or 2 can generate, transmit, receive, and/or display data associated with content of a conference session (e.g., live content, recorded content, etc.).

FIG. 11 is a diagram of an example flowchart 1100 that illustrates operations directed to generating a transcript and using the transcript to determine burst activity and/or an activity hotspot. In one example, the operations of FIG. 11 can be performed by components of the system 102 and/or a client computing device 106(N).

At operation 1102, a transcript associated with a conference session is generated.

At operation 1104, activity (e.g., notable events) that occur within the conference session is detected.

At operation 1106, for an individual notable event, a marker is added to the transcript in a position that reflects a time at which the individual notable event occurs with respect to the content of the conference session.

At operation 1108, the transcript is analyzed to determine a threshold number of notable events that occur within a threshold time period.

At operation 1110, a representation of an activity hotspot is added to the transcript and/or to an interactive timeline associated with the conference session.

In various examples, the analysis performed to determine a threshold number of notable events that occur within a threshold time period can focus on activity that is of interest to the user. For example, machine learning algorithm(s) can generate and/or update machine-learned parameters to determine which types of activity hotspots are more important to a user than others and/or to determine reasons why the types of activity hotspots are more important. The machine-learned parameters can be updated based on user feedback (e.g., whether the user performs a computer interaction with an activity hotspot representation on the interactive timeline). Thus, the system, over time, can learn what the user is more interested in and this provides an automated filtering of sorts. For instance, the interactive timeline may only be populated with activity hotspots that are likely of interest to the user. Or, the interactive timeline can graphically accentuate activity hotspots that are likely of interest to the user compared to other activity hotspots that are not likely of interest to the user (e.g., via a size of a representation, a color, etc.).

While the examples above are described with respect to an individual conference session, a user can search transcripts across multiple conference sessions or the user can search a large transcript that represents a continuous and on-going conference session (e.g., a team collaboration environment that spans days, weeks, months, years, etc.). In this way, the system can be configured to accept time boundaries and search conference sessions within the time boundaries for activity hotspots. The located activity hotspots can be summarized in a transcript, on an interactive timeline, and/or an activity graph.

FIG. 12 is a diagram of an example flowchart 1200 that illustrates operations directed to translating a transcript and other aspects of a conference session. In one example, the operations of FIG. 12 can be performed by components of the system 102 and/or a client computing device 106(N).

At operation 1202, content of a conference session is caused to be displayed in a first area of a graphical user interface.

At operation 1204, a transcript associated with the conference session is caused to be displayed in a second area of the graphical user interface. The transcript is displayed in a first language.

At operation 1206, an interactive timeline associated with the conference session is caused to be displayed in the graphical user interface

At operation 1208, a request to translate the transcript into a second language is received.

At operation 1210, the transcript is translated into the second language.

At operation 1212, an indication of an input (e.g., a hover input, a click, a selection, etc.) associated with a representation on the interactive timeline is received.

At operation 1214, a summary of the representation is translated into the second language based on the request to translate the transcript into the second language.

At operation 1216, the translated summary is caused to be displayed in association with a position of the representation on the interactive timeline.

The disclosure presented herein may be considered in view of the following example clauses.

Example Clause A, a system comprising: one or more processing units; and a computer-readable medium having encoded thereon computer-executable instructions to cause the one or more processing units to: generate a transcript associated with a conference session, the transcript including: text reflecting words spoken during the conference session; and markers that describe activity that occurs in the conference session; detect the activity that occurs in the conference session, the activity comprising a plurality of notable events; and for an individual notable event of the plurality of notable events, add a marker to the transcript in a position that reflects a time at which the individual notable event occurs with respect to content of the conference session, wherein the marker includes information that describes the individual notable event.

Example Clause B, the system of Example Clause A, wherein the individual notable event includes a reaction that reflects sentiment of a participant to the conference session.

Example Clause C, the system of Example Clause B, wherein the computer-executable instructions further causing the one or more processing units to: cause a menu of a plurality of possible reactions to be displayed in a graphical user interface associated with a client computing device, the graphical user interface configured to display the content of the conference session and the transcript; and receive, from the client computing device, an indication of a selection of the reaction that reflects the sentiment of the participant.

Example Clause D, the system of Example Clause B or Example Clause C, wherein the information that describes the individual notable event comprises an icon that depicts a sub-type of the reaction that reflects the sentiment of the participant and participant identification information.

Example Clause E, the system of any one of Example Clause A through Example Clause D, wherein the computer-executable instructions further cause the one or more processing units to: receive, from a client computing device, a search parameter associated with the individual notable event; search the transcript for the individual notable event using the search parameter; and cause at least a portion of the transcript to be displayed in a graphical user interface associated with the client computing device, the portion of the transcript including the marker in the position that reflects the time at which the individual notable event occurs with respect to the content of the conference session.

Example Clause F, the system of any one of Example Clause A through Example Clause E, wherein the computer-executable instructions further cause the one or more processing units to: analyze the transcript to determine that a threshold number of notable events occur within a threshold time period; and based at least in part on the determining that the threshold number of notable events occur within the threshold time period, add a representation of an activity hotspot to an interactive timeline associated with the conference session.

Example Clause G, the system of Example Clause F, wherein the computer-executable instructions further cause the one or more processing units to cause the content of the conference session, the transcript, and the interactive timeline to be displayed in a graphical user interface of a client computing device that is participating in the conference session.

Example Clause H, the system of Example Clause G, wherein the computer-executable instructions further cause the one or more processing units to: cause a user interface element associated with a graph of the activity that occurs in the conference session to be displayed in the graphical user interface; receive, from the client computing device, an indication of a selection of the user interface element; and cause the graph of the activity that occurs in the conference session to be displayed in the graphical user interface based at least in part on the indication.

Example Clause I, the system of Example Clause G, wherein the content of the conference session comprises live content or recorded content.

Example Clause J, the system of any one of Example Clause G through Example Clause I, wherein the computer-executable instructions further cause the one or more processing units to: receive, from the client computing device, an indication of a hover input associated with the representation of the activity hotspot on the interactive timeline; and cause a summary of the activity hotspot to be displayed in the graphical user interface in association with a position of the representation of the activity hotspot on the interactive timeline.

Example Clause K, the system of any one of Example Clause G through Example Clause I, wherein the computer-executable instructions further cause the one or more processing units to: receive, from the client computing device, an indication of a selection of the representation of the activity hotspot on the interactive timeline; and cause content of the conference session corresponding to a position of the representation of the activity hotspot on the interactive timeline to be displayed in the graphical user interface.

Example Clause L, the system of any one of Example Clause F through Example Clause K, wherein the computer-executable instructions further cause the one or more processing units to analyze, based at least in part on a search parameter, the transcript to determine that the threshold number of notable events that occur within the threshold time period are of a particular type, the representation of the activity hotspot added to the interactive timeline indicating burst activity of the particular type of notable event.

Example Clause M, the system of any one of Example Clause A through Example Clause L, wherein positions of the markers that describe the activity that occurs in the conference session are interspersed within the text reflecting the words spoken during the conference session based on times at which the activity occurs with respect to the content of the conference session.

Example Clause N, the system of any one of Example Clause A through Example Clause M, wherein a type of a notable event comprises one of: a participant joining the conference session, a participant leaving the conference session, a comment submitted to a chat conversation associated with the conference session, a modification made to file content displayed in the conference session, or a vote in a poll conducted during the conference session.

While the subject matter of Example Clauses A through N is described above with respect to a system, it is understood in the context of this document that the subject matter of Example Clauses A through N can additionally or alternatively be implemented by a device, as a method, and/or via computer-readable storage media.

Example Clause O, a method comprising: generating a transcript associated with a conference session, the transcript including text reflecting words spoken during the conference session and markers that describe activity that occurs in the conference session; detecting, by one or more processing units, the activity that occurs in the conference session, the activity comprising a plurality of notable events; and for an individual notable event of the plurality of notable events, adding a marker to the transcript in a position that reflects a time at which the individual notable event occurs with respect to content of the conference session, wherein the marker includes information that describes the individual notable event.

Example Clause P, the method of Example Clause O, wherein the individual notable event includes a reaction that reflects sentiment of a participant to the conference session, and the method further comprises: causing a menu of a plurality of possible reactions to be displayed in a graphical user interface associated with a client computing device, the graphical user interface configured to display the content of the conference session and the transcript; and receiving, from the client computing device, an indication of a selection of the reaction that reflects the sentiment of the participant.

Example Clause Q, the method of Example Clause O or Example Clause P, further comprising: analyzing the transcript to determine that a threshold number of notable events occur within a threshold time period; and based at least in part on the determining that the threshold number of notable events occur within the threshold time period, adding a representation of an activity hotspot to an interactive timeline associated with the conference session.

Example Clause R, the method of Example Clause Q, further comprising causing the content of the conference session, the transcript, and the interactive timeline to be displayed in a graphical user interface of a client computing device that is participating in the conference session.

While the subject matter of Example Clauses O through R is described above with respect to a method, it is understood in the context of this document that the subject matter of Example Clauses O through R can additionally or alternatively be implemented by a device, by a system, and/or via computer-readable storage media.

Example Clause S, a system comprising: one or more processing units; and a computer-readable medium having encoded thereon computer-executable instructions to cause the one or more processing units to: cause content of a conference session to be displayed in a first area of a graphical user interface displayed via a client computing device; cause a transcript associated with the conference session to be displayed in a second area of the graphical user interface, the transcript configured to display: text reflecting words spoken during the conference session; and markers that describe activity that occurs in the conference session; analyze, using machine-learned parameters, the transcript to determine that a threshold amount of activity of interest to a user occurs within a threshold time period; based at least in part on the determining that the threshold amount of activity of interest to the user occurs within the threshold time period, add a representation of an activity hotspot to an interactive timeline displayed in the graphical user interface; generate a summary for the activity hotspot, the summary describing one or more reasons the threshold amount of activity is of interest to the user; receive an indication of an input associated with the representation of the activity hotspot on the interactive timeline; and cause the summary of the activity hotspot to be displayed in association with a position of the representation of the activity hotspot on the interactive timeline.

Example Clause T, the system of Example Clause S, wherein the computer-executable instructions further cause the one or more processing units to update the machine-learned parameters based at least in part on the input associated with the representation of the activity hotspot on the interactive timeline.

While the subject matter of Example Clauses S and T is described above with respect to a system, it is understood in the context of this document that the subject matter of Example Clauses S and T can additionally or alternatively be implemented by a device, as a method, and/or via computer-readable storage media.

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware. p Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processing units; and
a computer-readable medium having encoded thereon computer-executable instructions to cause the one or more processing units to:
generate a transcript associated with a conference session, the transcript including:
text reflecting words spoken during the conference session; and
markers that describe activity that occurs in the conference session;
detect the activity that occurs in the conference session, the activity comprising a plurality of notable events; and
for an individual notable event of the plurality of notable events, add a marker to the transcript in a position that reflects a time at which the individual notable event occurs with respect to content of the conference session, wherein the marker includes information that describes the individual notable event.

2. The system of claim 1, wherein the individual notable event includes a reaction that reflects sentiment of a participant to the conference session.

3. The system of claim 2, wherein the computer-executable instructions further causing the one or more processing units to:
cause a menu of a plurality of possible reactions to be displayed in a graphical user interface associated with a client computing device, the graphical user interface configured to display the content of the conference session and the transcript; and
receive, from the client computing device, an indication of a selection of the reaction that reflects the sentiment of the participant.

4. The system of claim 2, wherein the information that describes the individual notable event comprises an icon that depicts a sub-type of the reaction that reflects the sentiment of the participant and participant identification information.

5. The system of claim 1, wherein the computer-executable instructions further cause the one or more processing units to:
receive, from a client computing device, a search parameter associated with the individual notable event;
search the transcript for the individual notable event using the search parameter; and
cause at least a portion of the transcript to be displayed in a graphical user interface associated with the client computing device, the portion of the transcript including the marker in the position that reflects the time at which the individual notable event occurs with respect to the content of the conference session.

6. The system of claim 1, wherein the computer-executable instructions further cause the one or more processing units to:
analyze the transcript to determine that a threshold number of notable events occur within a threshold time period; and
based at least in part on the determining that the threshold number of notable events occur within the threshold time period, add a representation of an activity hotspot to an interactive timeline associated with the conference session.

7. The system of claim 6, wherein the computer-executable instructions further cause the one or more processing units to cause the content of the conference session, the transcript, and the interactive timeline to be displayed in a graphical user interface of a client computing device that is participating in the conference session.

8. The system of claim 7, wherein the computer-executable instructions further cause the one or more processing units to:
cause a user interface element associated with a graph of the activity that occurs in the conference session to be displayed in the graphical user interface;
receive, from the client computing device, an indication of a selection of the user interface element; and
cause the graph of the activity that occurs in the conference session to be displayed in the graphical user interface based at least in part on the indication.

9. The system of claim 7, wherein the content of the conference session comprises live content or recorded content.

10. The system of claim 7, wherein the computer-executable instructions further cause the one or more processing units to:
receive, from the client computing device, an indication of a hover input associated with the representation of the activity hotspot on the interactive timeline; and
cause a summary of the activity hotspot to be displayed in the graphical user interface in association with a position of the representation of the activity hotspot on the interactive timeline.

11. The system of claim 7, wherein the computer-executable instructions further cause the one or more processing units to:
receive, from the client computing device, an indication of a selection of the representation of the activity hotspot on the interactive timeline; and
cause content of the conference session corresponding to a position of the representation of the activity hotspot on the interactive timeline to be displayed in the graphical user interface.

12. The system of claim 6, wherein the computer-executable instructions further cause the one or more processing units to analyze, based at least in part on a search parameter, the transcript to determine that the threshold number of notable events that occur within the threshold time period are of a particular type, the representation of the activity hotspot added to the interactive timeline indicating burst activity of the particular type of notable event.

13. The system of claim 1, wherein positions of the markers that describe the activity that occurs in the conference session are interspersed within the text reflecting the words spoken during the conference session based on times at which the activity occurs with respect to the content of the conference session.

14. The system of claim 1, wherein a type of a notable event comprises one of: a participant joining the conference session, a participant leaving the conference session, a comment submitted to a chat conversation associated with the conference session, a modification made to file content displayed in the conference session, or a vote in a poll conducted during the conference session.

15. A method comprising:
generating a transcript associated with a conference session, the transcript including text reflecting words spoken during the conference session and markers that describe activity that occurs in the conference session;
detecting, by one or more processing units, the activity that occurs in the conference session, the activity comprising a plurality of notable events; and
for an individual notable event of the plurality of notable events, adding a marker to the transcript in a position that reflects a time at which the individual notable event occurs with respect to content of the conference session, wherein the marker includes information that describes the individual notable event.

16. The method of claim 15, wherein the individual notable event includes a reaction that reflects sentiment of a participant to the conference session, and the method further comprises:
causing a menu of a plurality of possible reactions to be displayed in a graphical user interface associated with a client computing device, the graphical user interface configured to display the content of the conference session and the transcript; and
receiving, from the client computing device, an indication of a selection of the reaction that reflects the sentiment of the participant.

17. The method of claim 15, further comprising:
analyzing the transcript to determine that a threshold number of notable events occur within a threshold time period; and
based at least in part on the determining that the threshold number of notable events occur within the threshold time period, adding a representation of an activity hotspot to an interactive timeline associated with the conference session.

18. The method of claim 17, further comprising causing the content of the conference session, the transcript, and the interactive timeline to be displayed in a graphical user interface of a client computing device that is participating in the conference session.

19. A system comprising:
one or more processing units; and
a computer-readable medium having encoded thereon computer-executable instructions to cause the one or more processing units to:
cause content of a conference session to be displayed in a first area of a graphical user interface displayed via a client computing device;
cause a transcript associated with the conference session to be displayed in a second area of the graphical user interface, the transcript configured to display:
text reflecting words spoken during the conference session; and
markers that describe activity that occurs in the conference session;
analyze, using machine-learned parameters, the transcript to determine that a threshold amount of activity of interest to a user occurs within a threshold time period;
based at least in part on the determining that the threshold amount of activity of interest to the user occurs within the threshold time period, add a representation of an activity hotspot to an interactive timeline displayed in the graphical user interface;
generate a summary for the activity hotspot, the summary describing one or more reasons the threshold amount of activity is of interest to the user;
receive an indication of an input associated with the representation of the activity hotspot on the interactive timeline; and
cause the summary of the activity hotspot to be displayed in association with a position of the representation of the activity hotspot on the interactive timeline.

20. The system of claim 19, wherein the computer-executable instructions further cause the one or more processing units to update the machine-learned parameters based at least in part on the input associated with the representation of the activity hotspot on the interactive timeline.
